(19) United States
(12) Patent Application Publication
(10) Pub. No.: US 2019/0344350 A1
(43) Pub. Date: Nov. 14, 2019

(54) SUPERHARD CONSTRUCTIONS & METHODS OF MAKING SAME

(71) Applicant: ELEMENT SIX (UK) LIMITED, DIDCOT, OXFORDSHIRE (GB)

(72) Inventors: JONEE CHRISTINE PAREDES ZUNEGA, DIDCOT (GB); PETER ROBERT BUSH, DIDCOT (GB)

(73) Assignee: ELEMENT SIX (UK) LIMITED, DIDCOT, OXFORDSHIRE (GB)

(21) Appl. No.: 16/474,154

(22) PCT Filed: Dec. 22, 2017
(86) PCT No.: PCT/EP2017/084373

§ 371 Date: Jun. 27, 2019

(30) Foreign Application Priority Data
Dec. 31, 2016 (GB) 1622458.6

(51) Int. Cl. B22F 7/06; B22F 3/14; C04B 35/5831; C04B 35/645; C04B 35/76

(52) U.S. Cl. CPC B22F 7/06; B22F 3/14; C04B 35/5831; B22F 2003/244; C04B 35/76; B22F 2302/406; C04B 35/645

(57) ABSTRACT

A method of forming a super hard polycrystalline construction is disclosed as comprising placing a pre-formed structure of a first material into a canister, introducing a plurality of grains or particles of super hard material into the canister to locate the grains or particles in and/or around the pre-formed structure to form a pre-sinter assembly and treating the pre-sinter assembly at an ultra-high pressure of around 5 GPa or greater and a temperature to sinter together the grains of super hard material in the presence of a binder material to form the super hard polycrystalline construction comprising a body of polycrystalline super hard material having a first region of super hard grains in a binder material, and an embedded second region.

### FIELD

This disclosure relates to super hard constructions and methods of making such constructions, particularly but not exclusively to constructions comprising polycrystalline diamond (PCD) structures attached to a substrate, and tools comprising the same, particularly but not exclusively for use in rock degradation or drilling, or for boring into the earth.

### BACKGROUND

Polycrystalline super hard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of super hard tool inserts may be limited by fracture of the super hard material, including by spalling and chipping, or by wear of the tool insert.

Cutting elements such as those for use in rock drill bits or other cutting tools typically have a body in the form of a substrate which has an interface end/surface and a super hard material which forms a cutting layer bonded to the interface surface of the substrate by, for example, a sintering process. The substrate is generally formed of a tungsten carbide-cobalt alloy, sometimes referred to as cemented tungsten carbide and the super hard material layer is typically polycrystalline diamond (PCD), polycrystalline cubic boron nitride (PCBN) or a thermally stable product TSP material such as thermally stable polycrystalline diamond.

Polycrystalline diamond (PCD) is an example of a super hard material (also called a superabrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD.

Cemented tungsten carbide which may be used to form a suitable substrate is formed from carbide particles being dispersed in a cobalt matrix by mixing tungsten carbide particles/grains and cobalt together then heating to solidify. To form the cutting element with a super hard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline super hard diamond or polycrystalline CBN layer.

Cutting elements or tool inserts comprising PCD material are widely used in drill bits for boring into the earth in the oil and gas drilling industry. Rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

Methods used to improve the abrasion resistance of a PCD composite often result in a decrease in impact resistance of the composite.

The most wear resistant grades of PCD usually suffer from a catastrophic fracture of the cutter before it has worn out. During the use of these cutters, cracks grow until they reach a critical length at which catastrophic failure occurs, namely, when a large portion of the PCD breaks away in a brittle manner. These long, fast growing cracks encountered during use of conventionally sintered PCD, result in short tool life.

Furthermore, despite their high strength, polycrystalline diamond (PCD) materials are usually susceptible to impact fracture due to their low fracture toughness. Improving fracture toughness without adversely affecting the material's high strength and abrasion resistance is a challenging task.

There is therefore a need for a polycrystalline super hard composite such as a PCD composite that has good or improved abrasion, fracture and impact resistance and a method of forming such composites.

### SUMMARY

Viewed from a first aspect there is provided method of forming a super hard polycrystalline construction comprising:
placing a pre-formed structure of a first material into a canister;
introducing a plurality of grains or particles of super hard material into the canister to locate the grains or particles in and/or around the pre-formed structure to form a pre-sinter assembly; and
treating the pre-sinter assembly at an ultra-high pressure of around 5 GPa or greater and a temperature to sinter together the grains of super hard material in the presence of a binder material to form the super hard polycrystalline construction comprising a body of polycrystalline super hard material having a first region of super hard grains in a binder material, and an embedded second region.

### BRIEF DESCRIPTION OF THE DRAWINGS

Various versions will now be described by way of example and with reference to the accompanying drawings in which:

FIG. 1 is a perspective view of an example of a PCD cutter element or construction for a drill bit for boring into the earth;

FIG. 2 is a schematic cross-section of a conventional portion of a PCD micro-structure with interstices between the inter-bonded diamond grains filled with a non-diamond phase material;

FIG. 3 is a side view of a portion of a pre-formed structure to be included in a pre-sinter assembly of an example super hard construction prior to sintering;

FIG. 4 is a cross-section through a portion of the example of a sintered super hard construction including the pre-formed structure of FIG. 3;

FIGS. 5a and 5b are cross-sections through the sintered construction of FIG. 4 after the construction has been subjected to a first leaching treatment; and

FIG. 6 is a cross-section through the sintered construction of FIG. 4 after the construction has been subjected to an alternative leaching treatment to that shown in FIGS. 5a and 5b.

The same references refer to the same general features in all the drawings.

### DESCRIPTION

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material. In such a construction, a substrate may be attached thereto.

As used herein, polycrystalline diamond (PCD) is a type of polycrystalline super hard (PCS) material comprising a mass of diamond grains, a substantial portion of which are directly inter-bonded (intergrown) with each other and in which the content of diamond is at least about 80 volume percent of the material. In one example of PCD material, directly after sintering, interstices between the diamond grains may be at least partly filled with a binder material comprising a catalyst for diamond. As used herein, “interstices” or “interstitial regions” are regions between the diamond grains of PCD material.

A “catalyst material” for a super hard material is capable of promoting the growth or sintering of the super hard material.

The term “substrate” as used herein means any substrate over which the super hard material layer is formed. For example, a “substrate” as used herein may be a transition layer formed over another substrate.

As used herein, the term “integrally formed” means regions or parts are produced contiguous with each other and are not separated by a different kind of material.

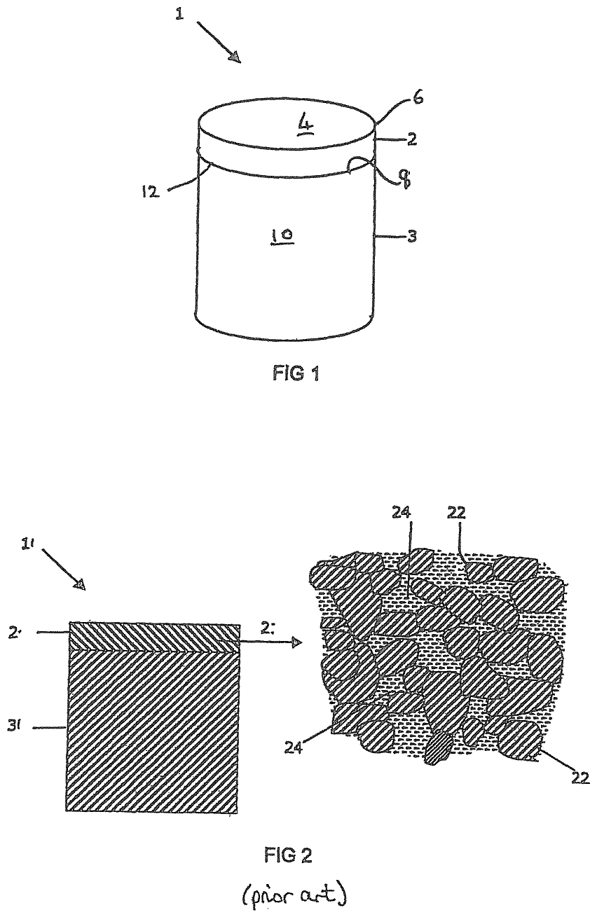

FIG. 1 is a schematic view of an example of a PCD super hard construction such as a cutting element 1 which includes a substrate 3 with a layer of super hard material 2 formed on the substrate 3. The substrate 3 may be formed of a hard material such as cemented tungsten carbide. The super hard material 2 may be, for example, high density polycrystalline diamond (PCD) comprising at least 80 vol % of interbonded (intergrown) diamond grains. The cutting element 1 may be mounted into a bit body such as a drag bit body (not shown) and may be suitable, for example, for use as a cutter insert for a drill bit for boring into the earth.

The exposed top surface of the super hard material opposite the substrate forms the cutting face 4, also known as the working surface, which is the surface which, along with its edge 6, performs the cutting in use.

At one end of the substrate 3 is an interface surface 8. As shown in FIG. 1, the substrate 3 is generally cylindrical and has a peripheral surface 10 and a peripheral top edge 12.

The working surface or “rake face” 4 of the polycrystalline composite construction 1 is the surface or surfaces over which the chips of material being cut flow when the cutter is used to cut material from a body, the rake face 4 directing the flow of newly formed chips. This face 4 is commonly also referred to as the top face or working surface of the cutting element as the working surface 4 is the surface which, along with its edge 6, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 1 in use.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

The substrate 3 is typically formed of a hard material such as a cemented carbide material, for example, cemented tungsten carbide.

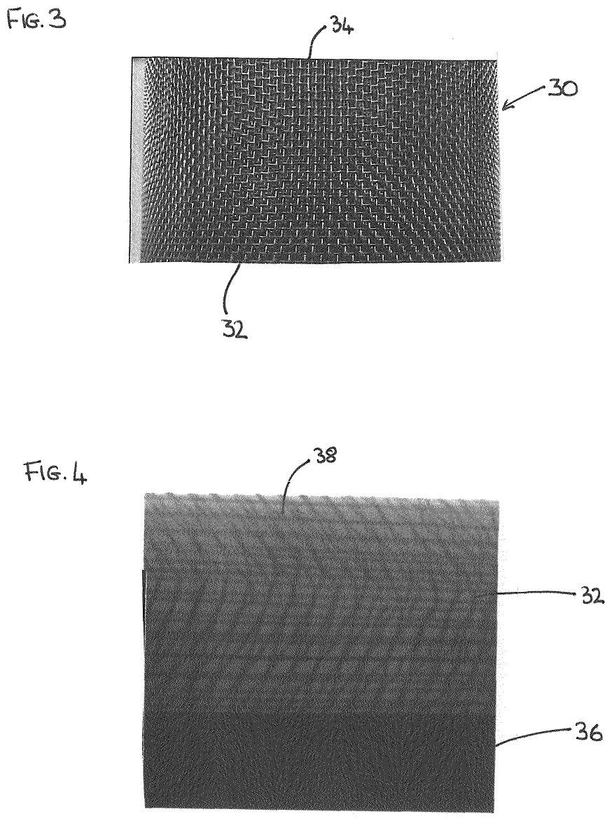

As shown in FIG. 2, during formation of a conventional polycrystalline composite construction 1, the interstices 24 between the inter-bonded grains 22 of super hard material such as diamond grains in the case of PCD, may be at least partly filled with a non-super hard phase material. This non-super hard phase material, also known as a filler material may comprise residual catalyst/binder material, for example cobalt.

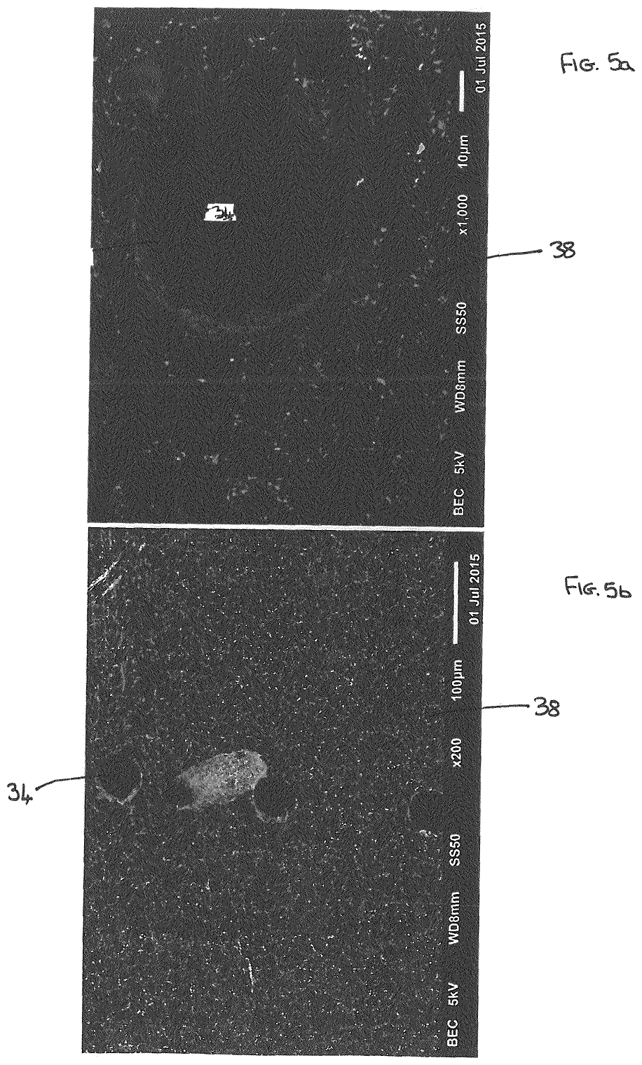

A first example of a composite material for use in forming the layer of polycrystalline super hard material 2 in a cutting element of the general shape of the cutter 1 shown in FIG. 1 in place of the conventionally structured PCD material of FIG. 2, is described with reference to FIGS. 3 to 6. The examples of such a composite material may comprise a three dimensionally (3D) continuous interpenetrating network of sintered polycrystalline super hard material such as PCD formed of interbonded diamond grains 38, and one or more secondary phases 32 formed from the pre-formed porous structure 30 of FIG. 3 embedded therein. The composite material may be attached to a substrate 36, as shown in FIG. 4. The structure 30 may be, for example a mesh structure with a plurality of apertures 34 therein and may be formed of materials such as a ceramic, a metal alloy, metals such as tungsten, hard metals, and/or polymers. The super hard material 38 may form, for example at least 10% of the composite by volume and up to around 95% of the composite by volume embedded structure and fills the apertures 34 in the structure 30.

The secondary phases may be chemically removed after the composite is manufactured to form a porous sintered super hard structure, as shown in FIGS. 5a and 5b, the apertures 34 in FIGS. 5a and 5b forming where the secondary phase was present prior to leaching, which may be through a conventional leaching technique such as electrochemical leaching, acid leaching, ultrasonic leaching and the like, depending on the material used as the second phase 30.

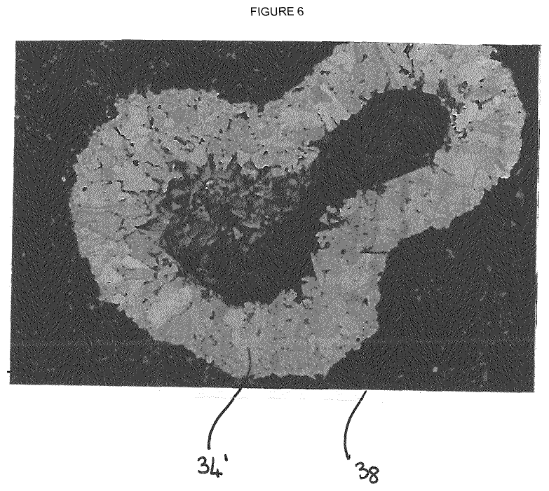

In some examples, such as that shown in FIG. 6, the second phase structure may be coated with a material that is not removed by post synthesis leaching treatments, the core of the second phase structure being removed in the treatment leaving the coating material 34′ in situ embedded in the polycrystalline material.

The construction and formation of examples of material as shown in FIGS. 3 to 6 are discussed in more detail below with reference to the following examples, which are not intended to be limiting.

### EXAMPLE 1:

Commercially available tungsten wire mesh 30 as shown in FIG. 3a was placed into a niobium cup together with a plurality of diamond particles having an average particle size of around 15 microns. In one method, diamond particles were added on top of the mesh inside a niobium cup and the assembly was subjected to mechanical vibration in order to force the diamond particles to fill the pores in the mesh. A tungsten carbide substrate with 13 wt % cobalt was placed on top of the diamond grains and mesh, inside the niobium cup, to form a pre-composite assembly. The pre-composite was then sintered at a pressure above 5 GPa and temperature of about 1400° C. in the presence of cobalt infiltrated from the WC-Co substrate. This formed an intergrown (interbonded) PCD skeleton with a three dimensionally continuously interpenetrating structure of tungsten mesh.

### EXAMPLE 2:

A tungsten wire mesh was introduced into a niobium cup and diamond powder added to fill the pores in the mesh. In this case a bimodal diamond powder was used comprising around 15 wt % of diamond particles having an average grain size of around 2 microns and 85 wt % of diamond particles having an average grain size of around 22 microns. A tungsten carbide substrate with 13 wt % cobalt was then added and the assembly was subjected to mechanical vibration to ensure the loose powders fill the empty spaces in the mesh with diamond powder. The pre-composite was then sintered at a pressure above 5 GPa and temperature of about 1400° C. in the presence of cobalt infiltrated from the WC-Co substrate to form an interbonded PCD skeleton with a three dimensionally continuously interpenetrating structure of tungsten mesh.

After sintering, the sintered structures were removed from the niobium cup and processed by conventional mechanical material removal techniques such as lapping or grinding to expose the polycrystalline super hard material and part of the embedded secondary phase which, depending on the nature of the material, may be chosen to retain substantially the same shape after sintering.

The composition of the secondary phase material may be selected depending on the desired end application for example it may be selected to be such that it will not react with the surrounding binder-catalyst for the super hard material during the sintering process, or chosen to be such that it will react with the binder-catalyst to form a reaction barrier and retard further reaction, or it may be coated with a further material which could have either of the aforementioned characteristics. Once sintered, depending on the intended end application, the constructions formed may then be further treated in any one of the following ways.

In one example, the construction is treated to remove residual catalyst material from interstitial spaces in the PCD material in addition to the secondary phase structure. This may be achieved, for example, by treating the structure in acid such as HF/HNO₃ to remove the residual catalyst binder material and the secondary phase structure, or by other known leaching methods such as electrochemical methods.

In another example, the construction is treated to remove only the secondary phase structure from the sintered product (as shown in FIGS. 5a, 5b). Where the secondary phase structure is formed of tungsten, for example, this may be achieved by treating the construction to a leaching process where the leaching mixture is an alkali solution such as Murakami's solution, or by applying an electrochemical potential between the residual binder-catalyst and the secondary phase material to remove only the secondary phase material. In such examples, the secondary phase material may be chosen to have one or more of a higher melting temperature than the binder catalyst used for the sintering of the polycrystalline super hard construction, have a low solubility in the binder catalyst, and a higher chemical potential than the binder catalyst.

In a further example where the secondary phase structure comprises a coated core material, the core material may be removed and the coating retained in the polycrystalline super hard construction (as shown in FIG. 6). Where the secondary phase structure is formed of a tungsten core material that has been coated in a material having a higher melting temperature than that of the binder catalyst of the super hard material, and/or low solubility therein, and/or having a higher chemical potential than the catalyst binder material, the leaching may be achieved by, for example, treating the construction to a leaching process where the leaching mixture is an alkali solution such as Murakami's solution, or by applying an electrochemical potential between the residual binder-catalyst and the core of the secondary phase material to remove only the core of the secondary phase material.

In another example, it may be desired to retain the secondary phase structure and remove only the residual catalyst binder material from the interstitial spaces of the super hard construction. This may be achieved using conventional leaching techniques for removing binder catalyst from polycrystalline super hard materials.

In a further example where the secondary phase structure comprises a coated core material, the core material may be retained and the coating removed in the polycrystalline super hard construction. Where the secondary phase structure is formed of a core material that has been coated in a material having a higher melting temperature than that of the binder catalyst of the super hard material, and/or low solubility therein, and/or having a lower chemical potential than the catalyst binder material, the leaching may be achieved by, for example, treating the construction to a leaching process where the leaching mixture is chosen to leach the coating material but not the core material, or by applying an electrochemical potential between the residual binder-catalyst and the core of the secondary phase material to remove only the core of the secondary phase material.

It is also possible, any one or more of the removal of the residual binder catalyst, core material of the secondary phase or coating of the secondary phase to backfill the porous structure or deposit one or more additional structures with desired properties that could, for example provide a material for instrumentation or act as one or more conductive paths.

It will be seen therefore that the selection of the secondary phase material may be made dependent on the desired end use of the construction.

Additionally, it will be seen that the secondary phase structure may be formed of any desire shape to suit the end application such as a mesh, one or more substantially straight structures, or one or more curved or spiral structures.

One or more constructions of the examples may gave non-abrasive applications such as acting as embedded conductive paths in electronic or other applications, cooling channels for instrumentation, or embedded multi-walled structures for various applications.

In abrasive applications, the embedded secondary phase structure or apertures formed by removal of said structure from the construction during post-sintering processing, may be effective as an inhibitor to crack propagation and thereby potentially assist in increasing the toughness of the composite structure.

A number of PCD compacts formed according to the Examples were compared in a vertical boring mill test with a commercially available polycrystalline diamond cutter element having the same average diamond grain size as that of the examples tested. In this test, the wear flat area was measured as a function of the number of passes of the cutter element boring into the workpiece. The results provide an indication of the total wear scar area plotted against cutting length. It will be seen that the PCD compacts formed according to the examples were able to achieve comparable and in some instances greater cutting length than that occurring in the conventional PCD compact which was subjected to the same test for comparison. Furthermore, in the examples a smaller wear scar area than the conventional PCD compact in this test was achieved with no spalling of the cutter.

Whilst not wishing to be bound by a particular theory, it is believed that the fracture performance of PCD may be improved through the introduction of a second phase which may assist in stopping crack propagation through the material and/or favourably divert cracks in the PCD material. The end result in application of the PCD material including such an interpenetrating network of second phase material of the type described is that, in use, where the wear rate is comparable to the crack growth rate, no cracks will be visible behind the wear scar thereby forming a smooth wear scar appearance with no chips or grains pulled out of the sintered PCD.

The addition of such a second phase may also have the effect of increasing the thermal stability of the PCD through the resultant lower cobalt content in the material of the invention compared to conventional PCD.

The composition and distribution of the second phase 30, may be tailored to the final application of the super hard material. It is believed possible to improve fracture resistance without significantly compromising the overall abrasion resistance of the material, which is desirable for PCD cutting tools.

Thus, it is believed that example constructions may provide a means of toughening PCD material without compromising its high abrasion resistance.

One or more example constructions comprising a polycrystalline super hard structure bonded to a cemented carbide support body may be further finished by, for example, grinding, to provide a PCD element which is substantially cylindrical and having a substantially planar working surface, or a generally domed, pointed, rounded conical or frusto-conical working surface. The constructions may be suitable for use in, for example, a rotary shear (or drag) bit for boring into the earth, for a percussion drill bit or for a pick for mining or asphalt degradation.

Furthermore, the super hard material of the various examples used to form the region of super hard material may be, for example, polycrystalline diamond (PCD) and/or polycrystalline cubic boron nitride (PCBN) and/or lonsdalite and the super hard particles or grains may be of natural and/or synthetic origin.

The substrate of the examples may be formed of a hard material such as a cemented carbide material and may include, for example, cemented tungsten carbide, cemented tantalum carbide, cemented titanium carbide, cemented molybdenum carbide or mixtures thereof. The binder metal for such carbides suitable for forming the substrate may be, for example, nickel, cobalt, iron or an alloy containing one or more of these metals and may include additional elements or compounds of other materials such as chromium, or vanadium. This binder may, for example, be present in an amount of 10 to 20 mass %, but this may be as low as 6 mass % or less.

In some examples, the region of super hard material may comprise PCBN. Components comprising PCBN are used principally for machining metals. PCBN material comprises a sintered mass of cubic boron nitride (cBN) grains. The cBN content of PCBN materials may be at least about 40 volume %. When the cBN content in the PCBN is at least about 70 volume % there may be substantial direct contact among the cBN grains. When the cBN content is in the range from about 40 volume % to about 60 volume % of the compact, then the extent of direct contact among the cBN grains is limited. PCBN may be made by subjecting a mass of cBN particles together with a powdered matrix phase, to a temperature and pressure at which the cBN is thermodynamically more stable than the hexagonal form of boron nitride, hBN. PCBN is less wear resistant than PCD which may make it suitable for different applications to that of PCD.

As used herein, a PCD or PCBN grade is a PCD or PCBN material characterised in terms of the volume content and size of diamond grains in the case of PCD or cBN grains in the case of PCBN, the volume content of interstitial regions between the grains, and composition of material that may be present within the interstitial regions. A grade of super hard material may be made by a process including providing an aggregate mass of super hard grains having a size distribution suitable for the grade, optionally introducing catalyst material or additive material into the aggregate mass, and subjecting the aggregated mass in the presence of a source of catalyst material for the super hard material to a pressure and temperature at which the super hard grains are more thermodynamically stable than graphite (in the case of diamond) or hBN (in the case of CBN), and at which the catalyst material is molten. Under these conditions, molten catalyst material may infiltrate from the source into the aggregated mass and is likely to promote direct intergrowth between the diamond grains in a process of sintering, to form a polycrystalline super hard structure. The aggregate mass may comprise loose super hard grains or super hard grains held together by a binder material. In the context of diamond, the diamond grains may be natural or synthesised diamond grains.

Different grades of super hard material such as polycrystalline diamond may have different microstructures and different mechanical properties, such as elastic (or Young's) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

The region of polycrystalline super hard material shown in the cutter elements of FIGS. 3 to 6 may comprise, for example, one or more grades of super hard material and may comprise one or more layers of super hard material which may differ in, for example, grain size and/or composition of the super hard material.

In particular, the grains of super hard material may be, for example, diamond grains or particles. In the starting mixture prior to sintering they may be, for example, multimodal, that is, the feed comprises a mixture of a coarse fraction of diamond grains and a fine fraction of diamond grains. In some embodiments, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction.

Sizing of diamond particles/grains into fine fraction, coarse fraction, or other sizes in between, may be through known processes such as jet-milling of larger diamond grains and the like.

In some examples, the cemented metal carbide substrate may, for example, be conventional in composition and, thus, may include any of the Group IVB, VB, or VIB metals, which are pressed and sintered in the presence of a binder of cobalt, nickel or iron, or alloys thereof. In some examples, the metal carbide is tungsten carbide.

While various versions have been described with reference to a number of examples, those skilled in the art will understand that various changes may be made and equivalents may be substituted for elements thereof and that these examples are not intended to limit the particular examples or versions disclosed.

For example, in some embodiments of the method, the PCD material may be sintered for a period in the range from about 1 minute to about 30 minutes, about 2 minutes to about 15 minutes, or from about 2 minutes to about 10 minutes.

In some examples of the method, the sintering temperature may be in the range from about 1,200 degrees centigrade to about 2,300 degrees centigrade, about 1,400 degrees centigrade to about 2,000 degrees centigrade, about 1,450 degrees centigrade to about 1,700 degrees centigrade, or about 1,450 degrees centigrade to about 1,650 degrees centigrade. Also, whilst it is conventional to sinter PCD using a catalyst such as cobalt, a range of catalysing materials comprising metals and/or non-metals may be used.

Furthermore, whilst the examples have been described in the context of cutter elements, it will be understood that the examples offer multi-functionally enhanced physical, mechanical, thermal and electrical properties and may equally find use in a range of applications such as cutting, machining and polishing of ferrous and non-ferrous materials. Other applications may include but are not limited to light weight structural parts in the aerospace, automotive and defence industries, in heater dissipaters, or in hot air filters.

1. A method of forming a super hard polycrystalline construction comprising:
placing a pre-formed structure of a first material into a canister;
introducing a plurality of grains or particles of super hard material into the canister to locate the grains or particles in and/or around the pre-formed structure to form a pre-sinter assembly; and
treating the pre-sinter assembly at an ultra-high pressure of around 5 GPa or greater and a temperature to sinter together the grains of super hard material in the presence of a binder material to form the super hard polycrystalline construction comprising a body of polycrystalline super hard material having a first region of super hard grains in a binder material, and an embedded second region.

2. The method of claim 1, wherein the pre-formed structure has a plurality of apertures therein, the step of introducing the plurality of grains or particles comprises locating the grains or particles of super hard material in the voids in the pre-formed structure.

3. The method of claim 1, wherein the step of placing the pre-formed structure into the canister is subsequent to the step of introducing the grains or particles of super hard material.

4. The method of claim 1, wherein the step of placing the pre-formed structure into the canister comprises placing a structure comprising any one or more of a ceramic, a metal, a metal alloy, a hardmetal, or a polymer into the canister.

5. The method of claim 1, wherein the step of placing the pre-formed structure into the canister comprises placing a structure comprising tungsten into the canister.

6. The method of claim 1, wherein the step of introducing a plurality of grains or particles of super hard material into the canister comprises introducing a plurality of grains or particles of any one or more of diamond, or cBN material into the canister.

7. The method of claim 1, wherein the step of introducing a plurality of grains or particles of super hard material into the canister comprises introducing a plurality of grains or particles of natural and/or synthetic origin.

8. The method of claim 1, further comprising treating the sintered structure to remove at least a portion of the binder material and/or at least a portion of the second region from the structure.

9. The method of claim 8, wherein the pre-formed structure comprises a core material coated with a coating material, the step of treating the sintered structure to remove at least a portion of the binder material and/or at least a portion of the second region from the structure comprising treating the structure to remove the coating from the second region leaving the core material embedded in the construction.

10. The method of claim 8, wherein the pre-formed structure comprises a core material coated with a coating material, the step of treating the sintered structure to remove at least a portion of the binder material and/or at least a portion of the second region from the structure comprising treating the structure to remove the core material from the second region leaving the coating material embedded in the construction.

11. The method of claim 8, further comprising after the step of removing at least a portion of the binder and/or second region the step of introducing an additional material into one or more voids in the construction created by the step of removing the at least a portion of the binder and/or second region.
